(19) United States
(12) Patent Application Publication
(10) Pub. No.: US 2018/0014918 A1
(43) Pub. Date: Jan. 18, 2018

(54) DENTAL PROSTHESIS ADAPTED TO AN EDENTULOUS JAW AND METHOD OF ADAPTING THE DENTAL PROSTHESIS TO THE EDENTULOUS JAW

(71) Applicant: TOUT DENTAIRE, Rueil Malmaison (FR)

(72) Inventor: Remy ATTALIN, Rueil Malmaison (FR)

(73) Assignee: TOUT DENTAIRE, Rueil Malmaison (FR)

(21) Appl. No.: 15/642,935

(22) Filed: Jul. 6, 2017

(30) Foreign Application Priority Data
Jul. 18, 2016 (FR) 1656821

(51) Int. Cl. A61C 13/107; A61C 13/07

(52) U.S. Cl. CPC A61C 13/0001; A61C 13/0025

(57) ABSTRACT

Method of adapting a dental prosthesis (1) to a first jaw (4) to fill a space between the dental prosthesis (1) and the first jaw (4), the first jaw (4) being artificial, said method comprising:
a step of modifying the shape of a thermosettable material, so that it fits the shape of an area of the dental prosthesis;
a step of positioning the dental prosthesis on the first jaw.

The invention concerns the domain of dental prostheses, and more particularly the adaptation of a dental prosthesis to an edentulous jaw.

An edentulous individual can no longer chew food. One solution to enable an edentulous individual to chew food properly proposes that he wear a dental prosthesis to replace the missing teeth.

Dental prostheses must be perfectly adapted to the shape of the gum of the edentulous jaw of the individual, so that the dental prosthesis is properly attached to the edentulous jaw. However, because the edentulous jaw naturally deforms over time, the dental prosthesis must be regularly readapted to the shape of the edentulous jaw. Such operation is commonly called relining.

Relining a dental prosthesis is generally performed by a professional, requiring the individual, while waiting for his appointment, to continue to wear a dental prosthesis improperly adapted to his jaw.

To reline a prosthesis, it is known to use a material capable of being adapted to the shape of the edentulous jaw of the individual and to retain that shape while solidifying with time. Such a material, for example, is sold under the name of AGGRIP'DENT PRO®. However, if an error is made during the relining operation, such material does not allow the error to be rectified.

The document US 2004/0248065 describes a dental prosthesis capable of being adapted to be jaw of an edentulous individual, without intervention of a professional. The dental prosthesis comprises a base, generally U-shaped, configured to cooperate with a gum of the individual. The base comprises cavities in which teeth are secured. The dental prosthesis also comprises a reline material, applied to the base, on the side opposite the teeth and closely fitted to the shape of the base. In order to adapt the dental prosthesis to his gum, the edentulous individual dips the dental prosthesis in hot water. The hot water enables the reline material to soften. The individual then positions the prosthesis in his mouth, the reline material pressed against his gum, then tightens the jaw or presses on the dental prosthesis with his fingers until the reline material cools. The reline material thus perfectly fits the shape of the individual's gum, and enables the prosthesis to be maintained on the gum.

Such a dental prosthesis effectively allows an unqualified individual to adapt it to his jaw without using a professional. However, such a dental prosthesis does not allow the relining of a dental prosthesis, and if an error is made during the relining operation, the thermosettable reline material does not allow the error to be rectified.

A first objective is to propose a method of adapting a dental prosthesis to an edentulous jaw.

A second objective is to propose a method of adapting a dental prosthesis that can be implemented without intervention of a professional, particularly a healthcare professional.

A third objective is to propose a method of adapting a dental prosthesis whereof the adaptation can be corrected simply and quickly.

A fourth objective is to propose a dental prosthesis adaptable to an edentulous jaw according to a method achieving the preceding objectives.

To that end, firstly a method is proposed of adapting a dental prosthesis to a first jaw to fill a space between the dental prosthesis and the first jaw, the first jaw being artificial, said method comprising:
a step of modifying the shape of a thermosettable material, so that it is closely fitted to the shape of an area of the dental prosthesis;
a step of positioning the dental prosthesis on the first jaw.

Such a method enables the adaptation of a dental prosthesis to a first jaw.

Said method also enables the relining of a dental prosthesis by an untrained individual.

Various additional characteristics can be foreseen, alone or in combination:
the method comprises, prior to the step of modifying the shape of the thermosettable material, the step of shaping the thermosettable plate from the thermosettable material, the thermosettable plate having one dimension far greater than the other two, so that the thermosettable plate is capable of covering the area of the dental prosthesis;
the method comprises, prior to the step of modifying the shape of the thermosettable material, a step of placing the thermosettable material on the dental prosthesis, facing the area of the dental prosthesis;
the method comprises, after the step of modifying the shape of the thermosettable material, a first step of removing burrs from the material on the dental prosthesis;
the method comprises, after the step of positioning the dental prosthesis, a step of placing the first jaw in contact with a second jaw complementary to the first jaw;
the method comprises, prior to the step of forming the thermosettable material, a step of coloring the thermosettable material;
the method comprises a reiteration of the step of modifying the shape of the thermosettable material and of the step of positioning the dental prosthesis, until the space between the dental prosthesis and the first jaw is filled.

Secondly, a dental prosthesis is proposed comprising a thermosettable plate closely fitted to the shape of the dental prosthesis, the thermosettable material being capable of filling a space between the dental prosthesis and a first jaw, said dental prosthesis being obtained according to a method as presented above.

Various additional characteristics can be foreseen, alone or in combination:
the area of the dental prosthesis defines the whole dental prosthesis;
the material belongs to the family of polycaprolactones.

Other characteristics and advantages of the invention will be seen more clearly and specifically from the following description of embodiments, which is provided with reference to the appended drawings in which:

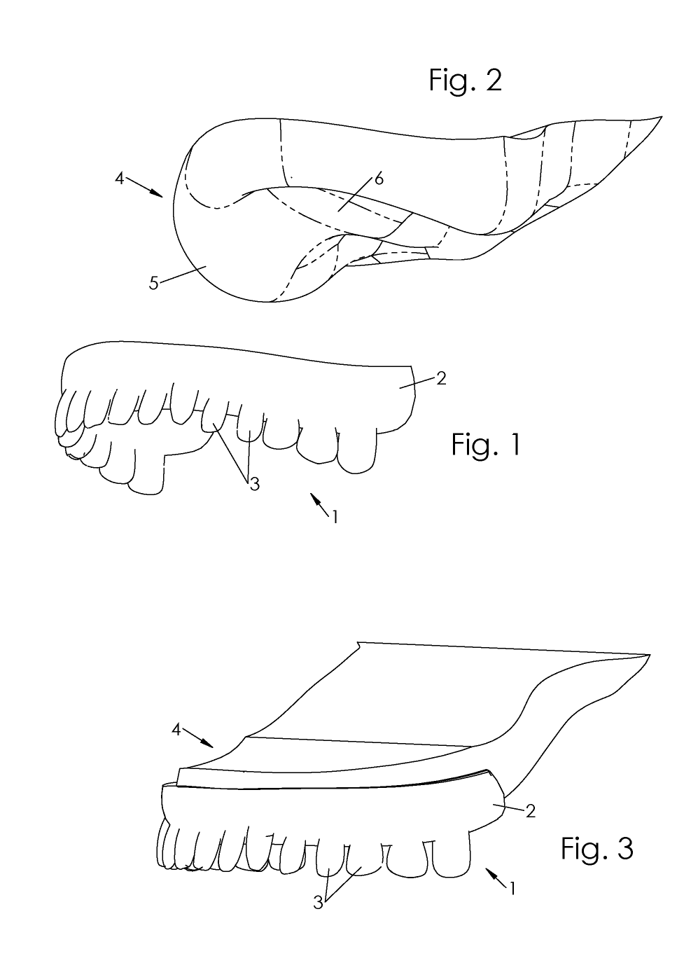

FIG. 1 is a schematic view in perspective of a dental prosthesis adapted to a first jaw;

FIG. 2 is a schematic view in perspective of the first jaw;

FIG. 3 is a schematic view in perspective of the dental prosthesis positioned on the first jaw;

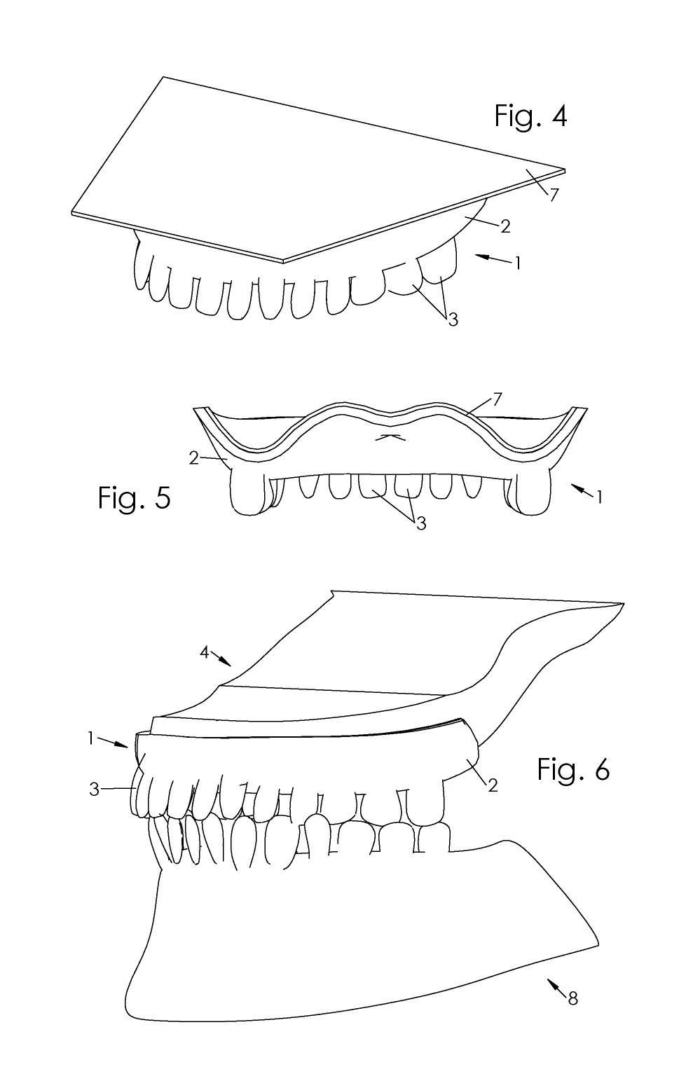

FIG. 4 is a schematic view in perspective of a step of placing a thermosettable plate on the dental prosthesis;

FIG. 5 is a schematic view in perspective of a step of modifying the shape of the thermosettable plate, so that it is closely fitted to the shape of the dental prosthesis;

FIG. 6 is a schematic view in perspective of a step of placing the first jaw in contact with a second jaw, complementary to the first jaw;

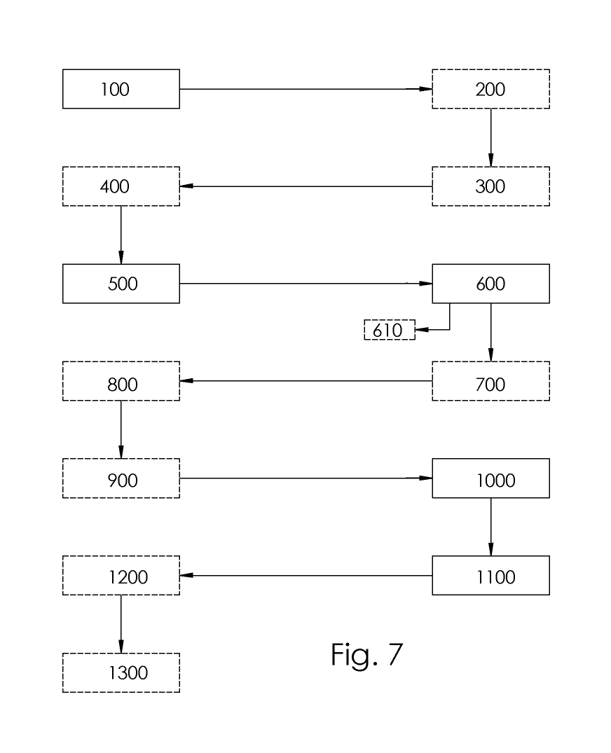

FIG. 7 is a schematic representation illustrating the steps relative to one embodiment of a method of fabricating a removable dental prosthesis.

Represented in FIG. 1 is a dental prosthesis 1 comprising a base 2 and teeth 3 attached to the base 2.

As illustrated in FIG. 3, according to a preferred embodiment, the dental prosthesis 1 is complete, i.e. it is capable of being attached to a first totally edentulous jaw 4, represented in FIG. 2.

According to embodiments not represented, the dental prosthesis 1 is partial, i.e. is capable of replacing one or more teeth of a first partially edentulous jaw 4.

The first jaw 4 in this instance is an upper jaw. However, according to an embodiment not illustrated, the first jaw 4 is a lower jaw. The first jaw 4 can be human, animal, artificial or a mold of an edentulous jaw of an individual.

The base 2 of the dental prosthesis 1 has a shape essentially identical to the shape of a gum 5 and a palate 6 of the first jaw 4.

According to the embodiment where the first jaw 4 is the lower jaw, the base 2 has a shape essentially identical to the shape of a gum of the lower jaw, so as not to hinder the movements of the tongue.

The dental prosthesis 1 also comprises a thermosettable plate 7, closely fitted to the shape of the base 2. The thermosettable plate 7 is joined to the base 2, the base 2 being disposed between the teeth 3 and the thermosettable plate 7.

According to the embodiment represented, the thermosettable plate 7 covers the entire base 2 of the dental prosthesis 1.

According to embodiments not represented, the thermosettable plate 7 covers one area of the base 2 of the dental prosthesis 1. The dental prosthesis 1 can also comprise a plurality of thermosettable plates 7, each covering one area of the base 2.

The thermosettable plate 7 also fits the shape of the first jaw 4, so as to fill a space between the base 2 of the dental prosthesis 1 and the first jaw 4. The thermosettable plate 7 is capable of being attached to the first jaw 4, attaching the dental prosthesis 1 to the first jaw 4.

The thermosettable plate 7 is produced from a material capable of preserving a specific shape.

According to a preferred embodiment, the material is thermosettable. Advantageously, the material belongs to the family of polycaprolactones.

According to the preferred embodiment, the material is in the form of granules. According to different embodiments, the material is in the form of lumps, tubes or plates.

According to a preferred embodiment, the base 2 and the teeth 3 of the dental prosthesis 1 are prefabricated. The dental prosthesis 1 is an old prosthesis of the individual, no longer adapting to the edentulous jaw of the individual and therefore having poor attachment to the edentulous jaw.

According to different embodiments, the dental prosthesis 1 is a standard model that is adaptable, by means of the thermosettable plate 7 to an edentulous jaw of an individual or a model poorly adapted to the edentulous jaw of the individual.

A method of adapting such a dental prosthesis 1 to a first jaw 4, whereof the steps are described herebelow, is illustrated in FIGS. 3 to 6. The steps are described and illustrated in FIG. 7 in their order of performance, according to the preferred embodiment.

The adaptation method described in the following enables the adaptation of the old prosthesis of an individual, also called relining of the prosthesis, but also the adaptation of a standard or previously poorly adapted dental prosthesis 1.

According to the preferred embodiment, the method comprises a first step 100 of heating the thermosettable material. The material, advantageously belonging to the family of polycaprolactones, is heated so that it becomes malleable. The heating temperature is between 60° C. and 70° C. The heating of the material is, for example, achieved by means of a hairdryer.

According to different embodiments, the material is heated in an oven, or by immersion in hot water.

The method comprises a step 200 of coloring the thermosettable material. The hot material is mixed with colorants in order to give it a color close to the color of the gum 5 and palate 6 of the first jaw 4. The colorants used are advantageously of natural origin.

According to different embodiments, the colorants are food type colorants. The material can also be colorless so as to retain its original color.

According to the preferred embodiment, the method comprises a second step 300 of heating the thermosettable material. The material, advantageously belonging to the family of polycaprolactones, is heated so that it becomes malleable. The heating temperature is between 60° C. and 70° C. The heating of the material is, for example, achieved by means of a hairdryer.

According to different embodiments, the material is heated in an oven, or by immersion in hot water.

If the thermosettable material is sufficiently malleable after the step 200 of coloring, or if the step 200 of coloring is not performed, the second step 300 of heating is unnecessary.

The method comprises a step 400 of shaping the thermosettable plate 7, from the thermosettable material. The material is flattened, forming the thermosettable plate 7. The thermosettable plate 7 is generally trapezoidal in shape, having one dimension far smaller than the other two.

According to an embodiment not represented, in the case where the first jaw 4 is a lower jaw, the thermosettable plate 7 is generally U-shaped, having one dimension far smaller than the other two.

As illustrated in FIG. 4, the method comprises a step 500 of placing the thermosettable plate 7 on the base 2 of the dental prosthesis 1. The thermosettable plate 7 is placed on the base 2, on the side opposite the teeth 3 of the dental prosthesis 1.

According to the embodiment represented, the dimensions of the thermosettable plate 7 are greater than the dimensions of the base 2.

According to an embodiment not represented, the thermosettable plate 7 is placed on the area of the base 2. The dimensions of the thermosettable plate 7 are greater than the dimensions of the area of the base 2.

According to a different embodiment, the step 500 of placement is performed directly after the first step 100 of heating or the second step 300 of heating. The thermosettable material is placed on the base 2, on the side opposite the teeth 3 of the dental prosthesis 1.

As illustrated in FIG. 5, the method comprises a step 600 of modifying the shape of the thermosettable plate 7.

According to the preferred embodiment, the step 600 of modifying the shape comprises a third phase 610 of heating the thermosettable plate 7. The plate 7, produced from a material advantageously belonging to the family of polycaprolactones, is heated so that it softens and closely fits the shapes of the base 2 of the dental prosthesis 1. The heating temperature is between 60° C. and 70° C. The heating of the thermosettable plate 7 is, for example, achieved by means of a hairdryer.

According to different embodiments, the thermosettable plate 7 is heated in an oven.

If the thermosettable plate 7 is sufficiently malleable after the step 500 of placement, the third phase 610 of heating is unnecessary and the step 600 of modifying the shape consists of pressing the thermosettable plate 7 against the base 2 of the dental prosthesis 1.

According to a different embodiment, the step 600 of modifying the shape is performed directly after the first step 100 of heating or the second step 300 of heating. The thermosettable material is pressed against the base 2 of the dental prosthesis 1.

The method comprises a first step 700 of removal of burrs from the thermosettable plate 7 on the base 2 of the dental prosthesis 1. The burrs are removed by means of a cutting tool.

According to the preferred embodiment, the method comprises a first step 800 of hardening the thermosettable plate 7.

According to the preferred embodiment, the dental prosthesis 1 is dipped into water at ambient temperature, cooling the plate 7 and causing it to harden. According to a different embodiment, the thermosettable plate 7 is cooled by ambient air, causing it to harden.

According to a preferred embodiment, the method comprises a fourth step 900 of heating the thermosettable plate 7. The plate 7, produced from material advantageously belonging to the family of polycaprolactones, is heated so that it becomes malleable. The heating temperature is between 60° C. and 70° C. The heating of the material is, for example, achieved by means of a hairdryer.

According to different embodiments, the thermosettable plate 7 is heated in an oven, or by immersion in hot water.

If the thermosettable plate 7 is sufficiently malleable after the step 600 of modifying the sheet, the fourth step 900 of heating is unnecessary.

As illustrated in FIG. 3, the method comprises a step 1000 of positioning the dental prosthesis 1 on the first jaw 4.

According to the embodiment represented, the thermosettable plate 7 of the dental prosthesis 1 is positioned against the gum 5 and the palate 6 of the first jaw 4.

According to an embodiment not represented, in the case where the first jaw 4 is a lower jaw, the thermosettable plate 7 is positioned against the gum of the first jaw.

The method comprises a step 1100 of flattening the thermosettable plate 7, illustrated in FIG. 6. A second jaw 8, complementary to the first jaw 4, is tightened against the first jaw 4 on which the dental prosthesis 1 is positioned, so that the dental prosthesis 1 is pressed against the first jaw 4 and the thermosettable plate 7 is deformed, filling the space between the dental prosthesis 1 and the first jaw 4.

The second jaw 8, in this instance, is a lower jaw. However, according to an embodiment not illustrated, the second jaw 8 is an upper jaw. The second jaw 8 can be human, animal, artificial or a mold of an edentulous jaw of an individual.

According to different embodiments, the step 1100 of flattening the dental prosthesis 1 against the first jaw 4 is achieved by pressing with a hand or with a device enabling a force to be exerted on the dental prosthesis 1.

According to a preferred embodiment, the method comprises a second step 1200 of removal of burrs from the thermosettable plate 7 on the base 2 of the dental prosthesis 1. The burrs are removed by means of a cutting tool.

The method comprises a second step 1300 of hardening the thermosettable plate 7.

According to the preferred embodiment, the dental prosthesis 1 is cooled by ambient air, causing it to harden. According to a different embodiment, the dental prosthesis 1 is dipped into water at ambient temperature, cooling the material and causing it to harden.

The method of adapting the dental prosthesis 1 can be repeated completely, or in part.

Such a method enables the adaptation of a dental prosthesis 1 to a first edentulous jaw 4 with biocompatible materials.

Said method of fabrication can be achieved easily, by an untrained person.

Said method offers a simple and quick correction of the adaptation of the dental prosthesis 1.

1. Method of adapting a dental prosthesis (1) to a first jaw (4) to fill a space between the dental prosthesis (1) and the first jaw (4), the first jaw (4) being artificial, said method comprising:
a step (600) of modifying the shape of a thermosettable material so that it is closely fitted to the shape of an area of the dental prosthesis (1);
a step (1000) of positioning the dental prosthesis (1) on the first jaw (4).

2. Method according to the preceding claim, characterized in that it comprises, prior to the step (600) of modifying the shape of the thermosettable material, a step (400) of shaping a thermosettable plate (7) from the thermosettable material, the thermosettable material being flattened so that three dimensions of the thermosettable plate (7) are such that one of the dimensions is greater than the other two dimensions, the thermosettable plate (7) being capable of covering the area of the dental prosthesis (1).

3. Method according to any one of the preceding claims, characterized in that it comprises, prior to the step (600) of modifying the shape of the thermosettable material, a step (500) of placing the thermosettable material on the dental prosthesis (1), facing the area of the dental prosthesis (1).

4. Method according to any one of the preceding claims, characterized in that it comprises, after the step (600) of modifying the shape of the material, a first step (700) of removal of burrs from the material on the dental prosthesis (1).

5. Method according to any one of the preceding claims, characterized in that it comprises, after the step (1000) of positioning the dental prosthesis (1), a step of placing the first jaw (4) in contact with a second jaw (8) complementary to the first jaw 4.

6. Method according to any one of the preceding claims, characterized in that it comprises, prior to the second step (400) of shaping the thermosettable material, a step (200) of coloring said material.

7. Method according to any one of the preceding claims, characterized in that it comprises a reiteration of the step (600) of modifying the shape of the thermosettable material and the step (1000) of positioning the dental prosthesis (1) until the space between the prosthesis (1) and the first jaw (4) is filled.

8. Dental prosthesis (1) comprising thermosettable material closely fitted to the shape of the dental prosthesis (1), the thermosettable material being capable of filling a space between the dental prosthesis (1) and a first jaw (4), said dental prosthesis (1) being obtained according to a method according to any one of the preceding claims.

9. Prosthesis (1) according to the preceding claim, characterized in that the area of the dental prosthesis (1) defines all of the dental prosthesis (1).

10. Prosthesis (1) according to either one of claims 8 to 9, characterized in that the thermosettable material belongs to the family of polycaprolactones.
